(19) United States
(12) Patent Application Publication
(10) Pub. No.: US 2024/0403506 A1
(43) Pub. Date: Dec. 5, 2024

(54) SIMULATION METHOD RELATING TO POSITIONERS USED DURING AN AIRCRAFT ASSEMBLY PHASE

(71) Applicant: Airbus Operations (S.A.S.), Toulouse (FR)

(72) Inventor: Jean-Marc DATAS, Toulouse (FR)

(21) Appl. No.: 18/673,471

(22) Filed: May 24, 2024

(30) Foreign Application Priority Data
May 30, 2023 (FR) 2305324

(51) Int. Cl. G06F 30/15; G06F 17/16; G06F 30/20

(52) U.S. Cl. CPC G06F 30/15; G06F 30/20; G06F 17/16

(57) ABSTRACT

A simulation of efforts applied to positioners to support the fuselage and the airfoil of an aircraft during operations of assembly is performed. The efforts are defined in a digital model of a load plan of the aircraft in assembly phase. The simulation is performed using the load plan digital model of the aircraft in assembly phase and a digital model of each positioner in the form of a set of three equivalent springs defined by three respective eigenvectors associated with three respective eigenvalues, in which the eigenvalues provide rigidity values and the eigenvectors provide directions on which the respective eigenvalues are applied. Thus, the simulation times are reduced.

### TECHNICAL FIELD

The disclosure herein relates to a simulation of efforts applied to positioners intended to support the fuselage and the airfoil of an aircraft during operations of assembly of the aircraft. The disclosure herein relates notably to the use of such a simulation in the context of a placement of such positioners.

### BACKGROUND

Before it can be put into service, an aircraft is constructed on an assembly line. During different assembly phases, the fuselage and the airfoil of the aircraft 100 rest on positioners in order to support the fuselage and the airfoil during the aircraft assembly operations.

So as to ensure the suitability of the positioners with respect to the fuselage and airfoil loads, digital simulations are performed based on finite element models of the positioners. Although it makes it possible to obtain great accuracy of modelling of the interactions of the fuselage and of the airfoil with the positioners, such a digital simulation approach requires very many complex computations and analyses, which can be spread out over simulation cycles of several days.

A new simulation cycle is moreover necessary when a modification of the placement of the positioners or a change of the load plan of the aircraft in assembly phase has to be assessed. It should also be noted that the great accuracy of these simulations performed on the basis of finite element models of the positioners can be compromised by defects of flatness and/or of homogeneity of the floor of the assembly line.

It is then desirable to provide a solution which makes it possible to mitigate these drawbacks. It is in particular desirable to provide a solution which makes it possible to reduce the time of the digital simulations that make it possible to ensure the suitability of the positioners with respect to the fuselage and airfoil loads during the assembly phases of an aircraft. It is also desirable to provide a solution which makes it possible to take into account, effectively, defects of flatness and/or of homogeneity of the floor of the assembly line.

### SUMMARY

A simulation method is thus disclosed here to perform a simulation of efforts applied to positioners intended to support the fuselage and the airfoil of an aircraft during operations of assembly of the aircraft, the efforts being defined in a digital model of a load plan of the aircraft in assembly phase, the simulation method being executed by a computing system, the method being such that the simulation is performed using the load plan digital model of the aircraft in assembly phase and a digital model of each positioner in the form of a set of three equivalent springs defined by three respective eigenvectors EVx, EVy, EVz associated with three respective eigenvalues K_{X}, K_{Y}, K_{Z}, in which the eigenvalues K_{X}, K_{Y}, K_{Z} provide rigidity values and the eigenvectors EVx, EVy, EVz provide directions on which the respective eigenvalues K_{X}, K_{Y}, K_{Z} are applied.

Thus the digital simulation time is greatly reduced through the use of the three equivalent springs defined by the three respective eigenvectors EVx, EVy, EVz associated with the three respective eigenvalues K_{X}, K_{Y}, K_{Z}.

According to an embodiment, the digital model of the load plan of the aircraft in assembly phase is a modelling by beams of the fuselage and of the airfoil of the aircraft in assembly phase, the simulation thus relating to an assembly station modelling in which the beams apply the efforts on the digital models of the positioners.

According to an embodiment, the eigenvalues K_{X}, K_{Y}, K_{Z} are grouped together on the diagonal of a 3×3 diagonal matrix, called rigidity matrix.

Also disclosed here is a computer program, which can be stored on a medium and/or downloaded from a communication network, in order to be read by a processor. This computer program comprises program code instructions for implementing the above-mentioned method in any one of its embodiments when the program is executed by the processor. A non-transient information storage medium storing such a computer program is also disclosed here.

Also disclosed here is a method for placing positioners intended to support the fuselage and the airfoil of an aircraft during operations of assembly of the aircraft, the method comprising a simulation phase including the above-mentioned simulation method in any one of its embodiments, the method further comprising: placing the positioners in pairs; performing load tests by placing on each pair of positioners a load test beam according to the load plan of the aircraft in assembly phase; performing measurements of displacement undergone by each positioner during the load tests; calibrating a rigidity adapter, so as to compensate, according to a predetermined margin, for each positioner concerned, a difference between the measurements and a displacement expected according to the simulation phase; and installing the calibrated rigidity adapter on each positioner concerned.

Thus, by virtue of the modelling simplicity obtained by the equivalent springs in the simulation method and the possible compensation produced by the rigidity adapter, a rapid and sure placement of the positioners can be performed with a view to the assembly of the aircraft.

According to an embodiment, the calibrated rigidity adapter is installed between a setting spacer superposed on an effort sensor and an inductive sensor suitable for detecting a presence of load.

According to an embodiment, the setting spacer, the effort sensor and the inductive sensor having substantially cylindrical forms and being mounted concentrically, the rigidity adapter has a conical spring washer form.

Also disclosed is a computing system configured to perform a simulation of efforts applied to positioners intended to support the fuselage and the airfoil of an aircraft during operations of assembly of the aircraft, the efforts being defined in a digital model of a load plan of the aircraft in assembly phase, the system being configured such that the simulation is performed using the load plan digital model of the aircraft in assembly phase and a digital model of each positioner in the form of a set of three equivalent springs defined by three respective eigenvectors EVx, EVy, EVz associated with three respective eigenvalues K_{X}, K_{Y}, K_{Z}, in which the eigenvalues K_{X}, K_{Y}, K_{Z} provide rigidity values and the eigenvectors EVx, EVy, EVz provide directions on which the respective eigenvalues K_{X}, K_{Y}, K_{Z} are applied.

### BRIEF DESCRIPTION OF THE DRAWINGS

The features of the disclosure herein mentioned above, and others, will become more clearly apparent on reading the following description of at least one example embodiment, the description being given in relation to the attached drawings, in which:

FIG. 1 schematically illustrates, in a top view, an aircraft;

FIG. 2 schematically illustrates, in perspective, a positioner;

FIG. 3 schematically illustrates, in perspective, a positioner interface block arrangement;

FIG. 4A schematically illustrates a set of three equivalent springs which model the positioner in the framework of digital simulations;

FIG. 4B schematically illustrates a rigidity matrix which groups together eigenvalues associated with the equivalent springs;

FIG. 5 schematically illustrates an example hardware platform that makes it possible to implement, in electronic circuitry form, a computing system suitable for performing digital simulations as described here; and

FIG. 6 schematically illustrates a method for placing positioners.

### DETAILED DESCRIPTION

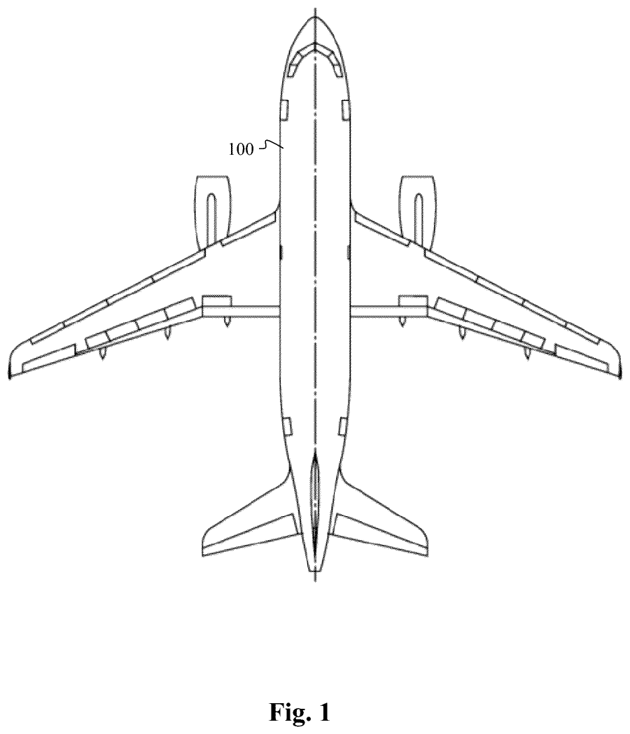

FIG. 1 illustrates, in a top view, an aircraft 100. Before it can be put into service, the aircraft 100 is constructed on an assembly line. During different assembly phases, the fuselage and the airfoil of the aircraft 100 rest on positioners. Since an aircraft is substantially symmetrical, the positioners 200 are used in pairs, placed on either side of a plane of (substantial) symmetry of the aircraft 100.

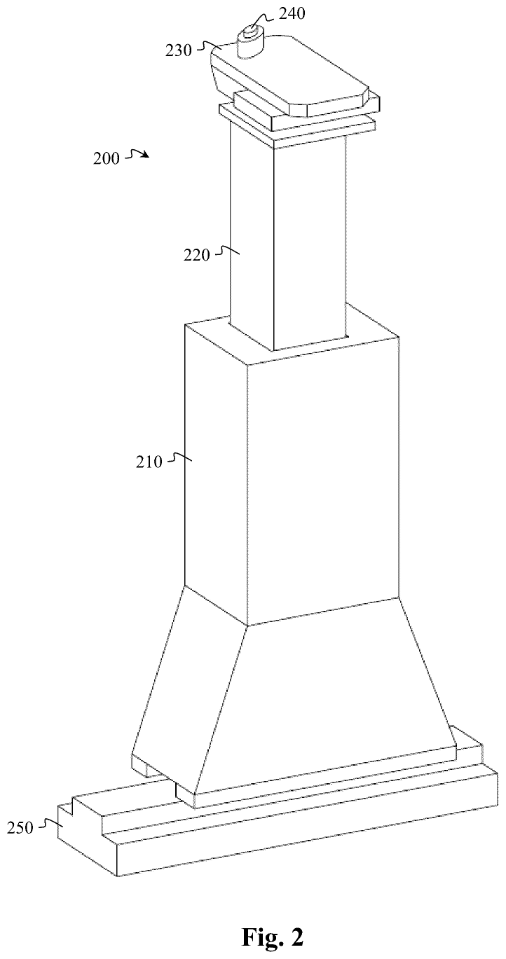

Such a positioner 200 is schematically illustrated, in perspective, in FIG. 2. The positioner 200 comprises a base 210 which is mounted to be movable in horizontal translation on a guidance system on the floor, typically a system of rails 250. The positioner 200 also comprises a mast 220, typically telescopic, mounted to be movable in vertical translation with respect to the base 210. These two translational movements make it possible to roughly place the positioner 200 with respect to the aircraft in assembly phase. The positioner 200 also comprises a compound table 230 at the top end of the mast 220 that makes it possible to refine the placement of the positioner 200 with respect to the aircraft in assembly phase. The positioner 200 also comprises, mounted on the compound table 230, an interface block 240 suitable for ensuring the placement of the fuselage or of the airfoil on the positioner 200.

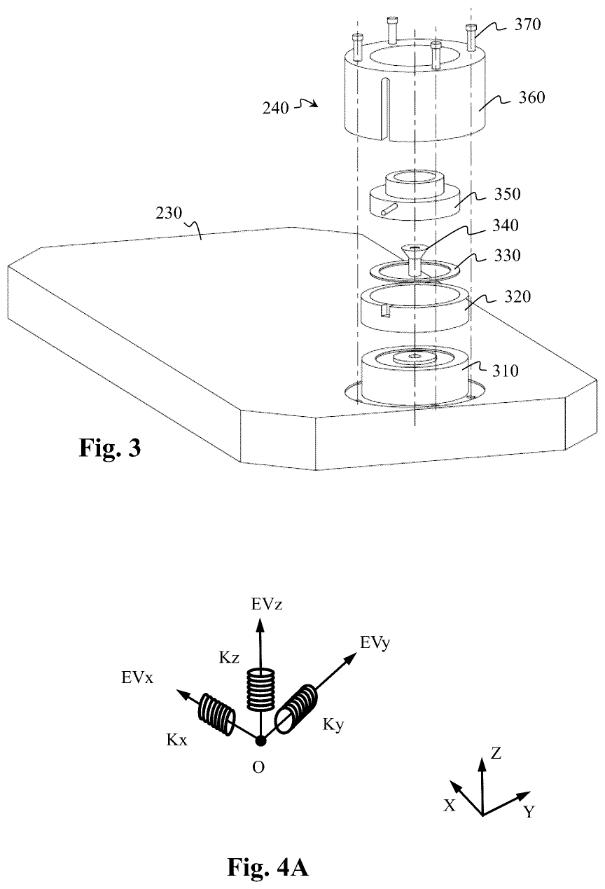

As schematically illustrated in FIG. 3, the interface block 240 comprises a housing 360 in which is placed an effort sensor 310 suitable for measuring efforts, particularly vertical efforts undergone by the positioner 200. Preferentially, the interface block 240 further comprises an inductive sensor 350 suitable for detecting a presence of load on the positioner 200. As detailed hereinbelow, the interface block 240 can comprise a rigidity adapter 330 which is calibrated following simulations and load tests.

FIG. 3 illustratively shows an assembly of the interface block 240 in which the effort sensor 310 is placed in a recess of the compound table 230. A setting spacer 320 adapted to set the effort sensor 310 and the inductive sensor 350, concentrically, is superposed on the effort sensor 310. An assembly screw 340 makes it possible to assemble the setting spacer 320 and the effort sensor 310. The rigidity adapter 330, on which the inductive sensor 350 rests, is placed in a recess of the setting spacer 320.

Preferentially, the effort sensor 310, the setting spacer 320 and the inductive sensor 350 are of substantially cylindrical forms. The rigidity adapter 330 then advantageously has a conical spring washer form (of calibrated rigidity).

The housing 360 covers the assembly formed by the effort sensor 310, the setting spacer 320, the rigidity adapter 330 and the inductive sensor 350, and is kept secured to the compound table 230 by a set of assembly screws 370. The housing 360 has an aperture on a top face, so as to allow the inductive sensor 350 to partly emerge in order for the inductive sensor 350 to be able to act as load presence detector.

So as to ensure the suitability of the positioners 200 with respect to the fuselage and airfoil loads, digital simulations are performed using a computing system (as for example presented hereinbelow in relation to FIG. 5).

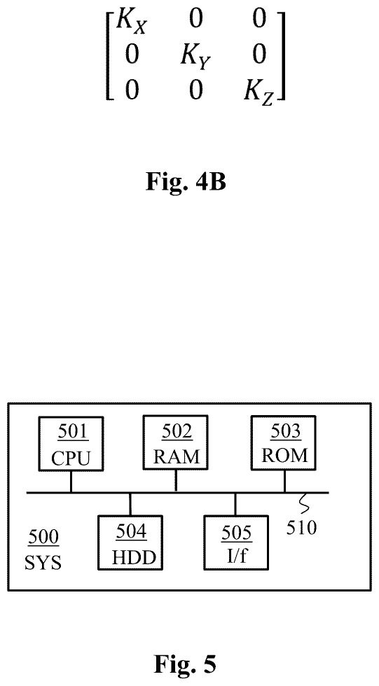

In the context of these digital simulations, each positioner 200 is modelled by a set of three equivalent springs, as schematically illustrated in FIG. 4A. These three equivalent springs are defined by a set of three respective eigenvectors EVx, EVy, EVz associated with three respective eigenvalues K_{X}, K_{Y}, K_{Z}. The respective eigenvalues K_{X}, K_{Y}, K_{Z} provide rigidity values expressed in N·m⁻¹ or a measurement unit which is a multiple thereof, typically in daN·mm⁻¹. The eigenvectors EVx, EVy, EVz provide directions on which the respective eigenvalues K_{X}, K_{Y}, K_{Z} are applied. The eigenvectors EVx, EVy, EVz are defined, in a common reference frame (X, Y, Z) (typically, a direct orthonormal reference frame), relative to a point O representative of an interface point between the positioner 200 and the aircraft 100 in assembly phase (i.e., point of contact with the fuselage or the airfoil).

The eigenvalues K_{X}, K_{Y}, K_{Z}, associated with the eigenvectors EVx, EVy, EVz, can be grouped together on the diagonal of a 3×3 diagonal matrix, called rigidity matrix:

$$[ \begin{matrix}{K}_{X} & 0 & 0 \\ 0 & {K}_{Y} & 0 \\ 0 & 0 & {K}_{Z}\end{matrix} ]$$

as also shown in FIG. 4B.

Thus, the digital simulations are greatly simplified compared to digital simulations performed on the basis of finite element models of the positioners.

FIG. 5 schematically illustrates an example hardware platform, in electronic circuitry form, that makes it possible to implement a computing system suitable for performing digital simulations as described here.

The hardware platform then comprises, linked by a communication bus 510: a processor or CPU (“Central Processing Unit”) 501; a RAM (“Random Access Memory”) memory 502; a read-only memory 503, for example of ROM (“Read Only Memory”) or EEPROM (“Electrically-Erasable Programmable ROM”) type or of Flash type; a storage unit, such as an HDD (“Hard Disk Drive”) 504, or a storage medium reader, such as an SD (“Secure Digital”) card reader; and an interface manager I/f 505.

The interface manager I/f 505 allows the hardware platform to interact with peripheral devices, such as human-machine interface peripheral devices (input, display of simulation results, et cetera), and/or with a communication network.

The processor 501 is capable of executing instructions loaded into the random-access memory 502 from the read-only memory 503, from an external memory, from a storage medium (such as an SD card), or from a communication network. When the hardware platform is powered up, the processor 501 is capable of reading instructions from the random-access memory 502 and executing them. These instructions form a computer program causing the implementation, by the processor 501, of all or part of the steps and operations described here in relation to the computing system.

All or part of the steps and operations described here can thus be implemented in software form by execution of a set of instructions by a programmable machine, for example a processor of DSP (“Digital Signal Processor”) type or a microcontroller, or be implemented in hardware form by a machine or a dedicated electronic component (“chip”) or a dedicated set of electronic components (“chipset”). Generally, the computing system comprises electronic circuitry adapted and configured to implement the steps and operations described here in relation to the computing system.

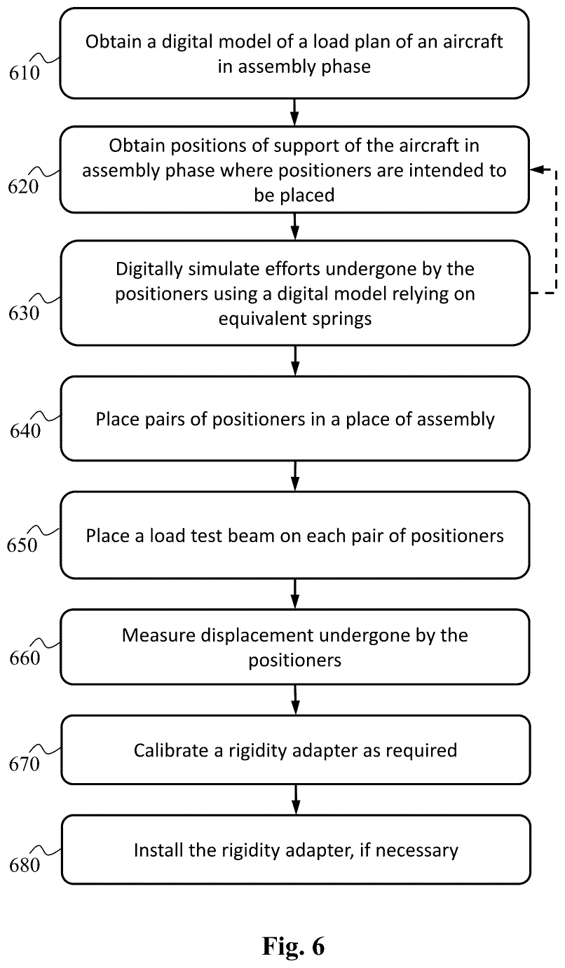

FIG. 6 schematically illustrates a method for placing positioners 200, in pairs, in an assembly line.

The method begins with a simulation phase.

In a step 610, the computing system obtains a digital model of a load plan of an aircraft in assembly phase. The load plan provides a description of load distribution during the assembly phase concerned and therefore defines the efforts expected on the positioners 200 (according to their respective positions). The pairs of positioners 200 are intended to support the aircraft during the assembly phase concerned.

In a step 620, the computing system obtains positions of support of the aircraft in assembly phase where the positioners 200 are intended to be placed (i.e., identification of the interface points). Thus, based on the load plan, the theoretical efforts applied to the positioners 200 are known.

In a step 630, the computing system performs a digital simulation of the efforts undergone by the positioners 200 according to the load plan. The digital simulation is performed using a digital model of each positioner 200 by equivalent springs, as described above (the three eigenvectors EVx, EVy, EVz associated with their three respective eigenvalues K_{X}, K_{Y}, K_{Z}). The digital simulation makes it possible to determine displacements undergone by the positioners 200 which are expected in light of the load plan.

Several iterations of the steps 620 and 630 can be performed so as to assess changes of support position of at least one pair of positioners 200, or changes of type of positioners (therefore with characteristics, notably in terms of rigidity).

In one embodiment, the digital model of the load plan of the aircraft in assembly phase is a modelling by beams of the fuselage and of the airfoil of the aircraft in assembly phase, the digital simulation thus relating to an assembly station modelling in which the beams apply the efforts expected on the digital models of the positioners 200 (springs).

With the simulation phase completed, the pairs of positioners are placed in a place of assembly in a step 640. The pairwise placement of positioners conforms to the support positions defined in the framework of the simulation performed in the step 630. The degrees of freedom of each positioner 200 allow such a placement in line with the framework of the simulation.

In a step 650, a load test beam is placed on each pair of positioners. The load test beam is adapted according to the load plan obtained in the step 610 with respect to the support positions defined in the framework of the simulation. The load characteristics of the load test beam are adjusted using weights placed (for example with attachment systems) at different points of the load test beam. The load tests can be performed successively on the pairs of positioners, or in parallel.

In a step 660, measurements of displacement undergone by each positioner 200 during the load tests are performed. The measured displacements are more particularly vertical displacements. These measurements are supplied to the computing system (for example, by input), which compares them to the displacements expected according to the simulation phase. If the measurements obtained conform, according to a predetermined margin, to the expected displacements, then the positioners 200 concerned do not warrant the addition of the rigidity adapter 330; otherwise, the method is continued in a step 670.

In the step 670, the computing system calibrates a rigidity adapter 330 for each positioner 200 concerned, so as to compensate, according to the predetermined margin, the difference between the measurements obtained in the step 660 and the displacements expected according to the simulation phase.

For example, the rigidity adapter 330 is calibrated so as to obtain a final rigidity K_{f} such that:

$${K}_{f} = \frac{{K}_{p} \times {K}_{a}}{{K}_{p} + {K}_{a}}$$

in which Kₚ is the rigidity of the positioner 200 without the rigidity adapter 330 and Kₐ is the rigidity of the rigidity adapter 330.

To calibrate the rigidity adapter 330, charts can also be used.

In a step 680, each rigidity adapter 330 thus calibrated is installed in position on the positioner 200 concerned.

Thus, defects of flatness of the floor of the assembly line and/or of the manufacturing tolerances of the positioners 200 and/or of the simulation inaccuracies can be compensated for.

Thus, by virtue of the modelling simplicity obtained by the equivalent springs as explained above and the possible compensation produced by the rigidity adapter, a rapid and sure placement (by virtue of the confirmations provided by the simulations) of the positioners can be performed with a view to the assembly of the aircraft.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for placing positioners to support a fuselage and an airfoil of an aircraft during assembly of the aircraft, the method comprising:
a simulation phase for performing a simulation of efforts applied to the positioners during the assembly of the aircraft, the efforts being defined in a digital model of a load plan of the aircraft in assembly phase, the simulation phase being executed by a computing system and performed using the load plan digital model of the aircraft in assembly phase and a digital model of each positioner in a form of a set of three equivalent springs defined by three respective eigenvectors EVx, EVy, EVz associated with three respective eigenvalues K_{X}, K_{Y}, K_{Z}, in which the eigenvalues K_{X}, K_{Y}, K_{Z} provide rigidity values and the eigenvectors EVx, EVy, EVz provide directions on which respective eigenvalues K_{X}, K_{Y}, K_{Z} are applied, the method further comprising:
placing the positioners in pairs;
performing load tests by placing on each pair of positioners a load test beam according to the load plan of the aircraft in assembly phase;
performing measurements of displacement undergone by each positioner during the load tests;
calibrating, by the computing system, a rigidity adapter, to compensate, according to a predetermined margin, for each positioner concerned, a difference between the measurements and a displacement expected according to the simulation phase; and
installing the calibrated rigidity adapter on each positioner concerned.

2. The method according to claim 1, wherein the digital model of the load plan of the aircraft in assembly phase is a modelling by beams of the fuselage and of the airfoil of the aircraft in assembly, the simulation thus relating to an assembly station modelling in which the beams apply the efforts on the digital models of the positioners.

3. The method according to claim 1, wherein the eigenvalues K_{X}, K_{Y}, K_{Z} are grouped together on a diagonal of a 3×3 diagonal matrix or rigidity matrix.

4. The method according to claim 1, wherein the calibrated rigidity adapter is installed between a setting spacer superposed on an effort sensor and an inductive sensor suitable for detecting a presence of load.

5. The method according to claim 1, wherein, the setting spacer, the effort sensor and the inductive sensor have substantially cylindrical forms and are mounted concentrically, the rigidity adapter having a conical spring washer form.
